(19) United States
(12) Patent Application Publication
(10) Pub. No.: US 2012/0061311 A1
(43) Pub. Date: Mar. 15, 2012

(54) METHOD FOR PRODUCING AN IN PARTICULAR FLAT FILTER ELEMENT

(75) Inventor: Thomas REINHOLD, Zaragoza (ES)

(73) Assignee: MANN+HUMMEL GMBH, Ludwigsburg (DE)

(21) Appl. No.: 13/295,373

(22) Filed: Nov. 14, 2011

Related U.S. Application Data
(63) Continuation of application No. PCT/EP2010/056392, filed on May 11, 2010.

(30) Foreign Application Priority Data
May 14, 2009 (DE) 10 2009 021 248.5

(51) Int. Cl. B01D 29/07; B32B 38/00; B32B 37/12; B23P 11/00; B32B 37/02

(52) U.S. Cl. 210/450; 210/435; 29/428; 156/227

(57) ABSTRACT

In a method for producing a flat filter element for fluids, a filter medium is folded to a filter bellows having end face folds and lateral edges. A solid filter element frame is provided. The filter bellows is fluid-tightly connected in an area of the end face folds to the solid filter element frame and the lateral edges of the filter bellows are fluid-tightly connected to the solid filter element frame so that the filter bellows is secured in the filter element frame.

### CROSS REFERENCE TO RELATED APPLICATIONS

This application is a bypass continuation application of international application No. PCT/EP2010/056392 having an international filing date of May 10, 2010 and designating the United States and published on Nov. 18, 2010 as WO 2010/130698 A1. The International Application claiming a priority date of May 14, 2009 based on prior filed German patent application No. 10 2009 021 248.5, the entire contents of the aforesaid international application and the aforesaid German patent application being incorporated herein by reference in entirety to the fullest extent permitted by the law.

### TECHNICAL FIELD

The invention relates to a method for producing an in particular rectangular flat filter element for fluids, in particular for a motor vehicle, in which the filter medium is folded to a filter bellows.

### BACKGROUND OF THE INVENTION

The invention concerns a method for producing an in particular rectangular flat filter element for fluids, in particular for a motor vehicle, in which the filter medium is folded to a filter bellows.

Moreover, the invention concerns a filter element, in particular a rectangular flat filter element, for fluids, in particular for a motor vehicle, with a filter bellows of a folded filter medium.

Moreover, the invention concerns a filter device for fluids, in particular for a motor vehicle, with a filter housing for receiving a flat filter element.

The end face folds in the context of the invention are the two outer folds on opposite end faces of the filter bellows. The end edges are the two free edges of the filter medium that extend along the end face folds and delimit the end face folds at the end faces of the filter bellows. The lateral edges of the filter bellows are the two other free edges of the filter bellows that extend between the end edges and extend in accordance with the fold configuration of the filter bellows. The fold edges are the edges where the filter medium is folded. In case of a zigzag-shaped folded parallelepipedal filter bellows, the end edges and the fold edges in general are straight and extend parallel to each other. The lateral edges extend zigzag-shaped and perpendicular to the end edges and the fold edges.

In flat filter elements the filter media are not closed, i.e., the end face folds as well as the lateral edges are not connected to each other. In contrast thereto, in case of round filter elements the filter media are closed, i.e., their end face folds are connected to each other. Flat filter elements can be of a planar shape but also can have bends in various directions.

In commercially available rectangular flat filter elements for fluids, neighboring folds of a folded filter bellows are fluid-tightly connected at the lateral edges by means of a melt adhesive. The filter bellows, after folding and gluing, is cut to a predetermined length. The flat filter elements are moreover furnished with a polyurethane (PUR) seal for fluid-tight separation of the unfiltered fluid side from the filtered fluid side.

In order to fulfill the requirements with respect to signal quality of the air mass airflow meter that is arranged behind the filter element, in particular with respect to signal noise and the course of the characteristic line, it is necessary to produce flat air filter elements so as to have, as much as possible, uniformly reproducible features such as dimensional accuracy, fold extension, fold stability, and effective filter surface area.

Moreover, in particular for space reasons and economical reasons, it is desirable to realize an optimal, preferably as large as possible, effective filter surface area with outer dimensions as small as possible.

### SUMMARY OF THE INVENTION

An object of the present invention is to provide a method for producing flat filter elements, flat filter elements, and a filter device of the aforementioned kind in which optimal effective filter surface areas can be realized, as much as possible, in a reproducible fashion.

In accordance with the present invention, this is achieved in that the filter bellows in areas of its end face folds is connected fluid-tightly with a solid filter element frame and the lateral edges of the filter bellows are fluid-tightly connected with the filter element frame in such a way that the filter bellows is secured in the filter element frame.

According to the invention, the filter medium is folded to the filter bellows and cut to size before it is connected with the filter element frame. This can be realized, for example, in a continuous method with a blade that is moving along. In this way, it is possible to exactly predetermine the fold number and thus the filter surface area. Subsequently, the filter bellows is connected all round in a fluid-tight way with the filter element frame. In this connection, the filter bellows can be provided in or on the filter element frame also with an arc shape or curvature. Also, a correspondingly shaped filter element frame can be used. The filter bellows is stably connected to the filter element frame in the finished filter element so that deformations of the filter bellows in particular as a result of mechanical effects and effects of moisture or temperature are minimized. The surface area of the filter medium that is required for connection to the filter element frame can be limited to a minimum so that the ratio of effective filter surface area to employed medium surface can be optimized. It is thus possible to connect the lateral edges and the areas of the end face folds to the filter element frame in a reproducible way, preferably within a narrow area compared to the entire filter surface area. It is not required to maintain safety spacings to the respective edges. The flat filter element can thus be mounted simply in an appropriate filter housing in such a way that a filtered fluid side of the flat filter element is separated fluid-tightly from the unfiltered fluid side. Moreover, the filter element frame can be sealed with a separate sealing device relative to the filter housing that is designed as a permanent component (technical or economic life-time component). The sealing device is separate from the filter bellows so that a filter surface area as large as possible can be integrated in the available mounting space. This increases moreover the reproduceability of the effective filter surface area. The seal in this connection can be attached to the filter element frame or to a part of the filter housing.

In an advantageous embodiment of the method, the filter medium can be folded in a zigzag shape. In this way, an optimal ratio of maximum effective filter surface area to minimal mounting space can be realized.

In a further advantageous embodiment of the method, the filter medium can be folded such that the end edges of the end face folds are located at the same side of the filter bellows. In this way, both end edges can be connected in a space-saving way preferably in a common plane with the filter element frame. In this way, they can form the outermost boundary of the filter bellows at the end faces so that the effective filter surface area is enlarged.

Advantageously, at least one of the end edges and/or at least one fold edge in the area of one of the end face folds can be fluid-tightly connected with the filter element frame. The connection of the end edges and of the fold edges with the filter element frame is ideally realized only along a line, respectively. so that the loss of active filter surface area is minimized. In contrast thereto, the connection across the surface area of an end face fold consumes more surface area of the filter bellows or filter medium.

In a further advantageous embodiment of the invention, the filter bellows in the areas of its end face folds can be fluid-tightly connected with a base frame part of the filter element frame and the lateral edges of the filter bellows can be fluid-tightly connected with lateral frame parts of the filter element frame. The lateral frame parts can preferably have closed surfaces for attachment of the filter bellows in order to enable a gap-free connection with the end face folds. This improves the stability of the flat filter element and counteracts a deformation of the filter bellows in particular into a sickle shape that may be caused by the effects of temperature and/or moisture.

Advantageously, the lateral frame parts and the base frame part can be connected fluid-tightly with each other; this facilitates separation of the filtered fluid side of the flat filter element from the unfiltered fluid side.

Moreover, advantageously between the lateral frame parts an end face frame part can be arranged, respectively, and can be fluid-tightly connected with the base frame part and the lateral frame parts. In this way, the filter element frame can be closed all around which is positive with respect to stability. Moreover, in this way a simple efficient sealing action of the filter element in the filter housing can be realized.

In order to increase the seal-tightness of the filter element frame and to improve the separation of the filtered fluid side from the unfiltered fluid side, advantageously the lateral frame parts and the end face frame parts can be glued or fused/welded fluid-tightly to each other.

In order to optimize the connection between the filter medium and the base frame part, in particular in order to optimize fluid tightness, advantageously, the end face folds can be pressed with guide members of the end face frame parts against the base frame part. The guide members can be particularly embodied as wedge-shaped attachments on the surfaces of the end face frame parts that are facing the filter bellows.

In a further advantageous embodiment of the method, the initially separate lateral frame parts can be fluid-tightly connected with the separate base frame part and optionally with the separate end face frame parts. Separate frame parts can be produced separate from each other in a simple way. They have also the advantage that they can be pressed simultaneously and thus in a time-saving way from different directions against the filter bellows and connected to it in this way.

In an alternative advantageous embodiment of the method, the lateral frame parts, the base frame part, and optionally the end face frame parts, can be monolithically connected to each other, preferably by means of bending connections, in particular film hinges, and in this way configured to form the filter element frame. The filter element frame can thus be produced in one piece in particular in a flat shape and, if needed, can be cut to size or can be processed in other ways. The lateral frame parts and optionally the end face frame parts can be folded by means of the bending connections relative to the base frame part in order to bring the filter element frame into the desired shape. In this way, the filter bellows is incorporated into the filter element frame. The film hinges can be produced by embossing or notching at the folding locations.

Advantageously, the filter bellows can be connected to the filter element frame by means of an adhesive, in particular by means of a highly viscous (low flowability) adhesive or an adhesive film that can be activated, in particular heated, to thereby become formable, or by fusing/welding, in particular hot gas, hot plate, or infrared (IR) fusing/welding. The above listed methods enable a precise reproducible connection of the filter bellows with the filter element frame; the filter surface area that is required for the connection is minimized, and therefore the effective filter surface area is maximized. Highly viscous adhesive remains during the curing or hardening time at the connecting location. Also, it only penetrates to a minimal definable degree into the filter bellows. Viscous adhesive can be applied simply before assembly onto the filter element frame. After application, it remains substantially shape-stable. The filter bellows is pressed into the adhesive material and is fixed positionally by it during and after curing/hardening. The special adhesive film can be premounted on the filter element frame and is activated upon assembly of the filter bellows by heat. The activated adhesive film encloses the lateral edges of the filter medium and connects them upon curing/hardening with the filter element frame. In this way, the filter element frame and the filter bellows can be prefabricated as a module so that the manufacturing process can be designed more flexibly. The connecting process of fusing/welding is particularly beneficial when the filter element frame is made of a material that can be softened by heat application, in particular a plastic material. In this case, the adhesive or the adhesive film is no longer needed. Moreover, the surface of the filter element frame can be softened precisely at a desired spot or surface area but also in the depth direction, in particular by hot plate welding, so that the penetration depth of the filter bellows into the surface of the filter element frame can be defined optimally. In this way, it is possible to employ reproducibly as little filter surface area as possible for the connection and, in spite of this, realize an optimal fluid tightness.

In a further advantageous embodiment, the filter element frame can be provided with receptacles, in particular grooves or depressions, into which the adhesive, in particular a melt adhesive or a highly viscous adhesive, is introduced and the areas of the end face folds that are to be connected to the filter element frame and/or the lateral edges of the filter bellows are pressed into the corresponding receptacles that are provided with the adhesive. In these receptacles, the appropriate areas of the filter bellows are positioned until the adhesive has cured or hardened and the adhesive provides the fixation of the filter bellows.

In another advantageous embodiment of the method, the filter bellows can be connected in particular by means of an adhesive with little flowability (high viscosity) with the filter element frame and the filter element frame can be swiveled or moved back and forth in different spatial directions until hardening of the adhesive occurs. The back-and-forth swivel action counteracts essentially the force of gravity and prevents that the adhesive will flow off vertical surfaces of the filter element frame. In this way, vertical and horizontal surfaces of the filter element frame can be connected simultaneously with the filter bellows; this reduces the production time.

The object is further solved by a filter element in which the filter bellows, in areas of its end face folds, is connected fluid-tightly with a solid filter element frame and the lateral edges of the filter bellows are fluid-tightly connected with the filter element frame in such a way that the filter bellows is secured in the filter element frame. Such a flat filter element has a precisely reproducible fold number and effective filter surface area. It is shape-stable with regard to the effects of temperature and moisture. It can be introduced simply into a corresponding filter housing and sealed relative to the filter housing in order to seal-tightly separate the filtered fluid side of the flat filter element from the unfiltered fluid side.

The functions of shaping and stabilizing of the filter bellows and sealing relative to the housing are moreover decoupled. In this way, optimal materials can be used for the respective function. For stabilization the filter element frame is preferably made of a solid material, in particular of a plastic material that can be easily processed. For the sealing function, an elastic material can be used. Moreover, the ratio of effective filter surface area to the external dimensions of the filter element can be optimized. A packaging for the filter element can be designed to be extremely space-saving because the filter element frame can be produced without projecting rims as they are known in particular from prior art polyurethane (PUR) seals. The advantages of the above described manufacturing method apply in the same way also to the filter element itself.

In an advantageous embodiment, the filter medium can be folded in a zigzag shape in order to optimize the ratio of effective filter surface area to the required size or space.

Advantageously, the end edges of the end face folds can be located at the same side of the filter bellows so that the end edges can be attached space-savingly in a planar surface of the filter element frame.

Moreover, at least one of the end edges of the end face folds and/or a fold edge in the area of at least one of the end face folds can be fluid-tightly connected to the filter element frame. If this way, the losses of filter surface area that are caused by the connection to the filter element frame can be minimized.

In a further advantageous embodiment, the folded filter medium in the areas of its end face folds can be fluid-tightly connected to a base frame part of the filter element frame and the lateral edges of the filter bellows can be fluid-tightly connected with a lateral frame part of the filter element frame. In this way, the filter bellows is sealed along its edges relative to the filter element frame.

Advantageously, the filter element frame may have at least one end face frame part that may have guide members with which the end face folds are pressed against the base frame part in order to improve the connection of the filter bellows with the base frame part.

In a further advantageous embodiment, the lateral frame parts, the base frame part, and optionally the end face frame parts can be connected monolithically with each other, preferably by means of bending connections, in particular film hinges. The filter element frame can therefore be pre-manufactured as a substantially flat space-saving component and the frame parts are then appropriately folded during the connecting process with the filter bellows by means of the bending connections.

In a further advantageous embodiment, a part of the filter housing is formed by the filter element frame, preferably by the lateral frame parts. The filter element in this connection can be clamped, for example, by means of a tie rod, between the adjoining housing parts or by means of snap hooks or screw connections can be connected on both sides with the adjoining housing parts.

Moreover, advantageously a sealing device can be provided that is suitable, when arranging the filter element in a filter housing, to fluid-tightly separate a filtered fluid side of the filter element from the unfiltered fluid side. The sealing device can be optimized with respect to shape and material to the sealing function because it has no further function, for example, securing or stabilizing function. In particular, it is not needed for the stabilization of the filter bellows. The sealing device can also be provided as a permanent component (technical life-time component) in the filter housing so that only the filter element must be exchanged, as needed.

In a further advantageous embodiment, the filter element is preferably rectangular but it can also be of a trapezoidal shape.

The object is moreover solved by a filter device for fluids in particular of a motor vehicle with a filter housing for receiving a filter element according to the invention.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 shows a blank of the filter element frame of the filter element;

FIG. 2 shows a section according to section line II-II of FIG. 1;

FIG. 3 shows the blank of the filter element frame with notches or grooves applied for forming the bending locations;

FIG. 4 shows the production step of positioning of the folded filter medium onto the blank of the filter element frame;

FIG. 5 shows the filter element production in a step following the step of FIG. 4;

FIG. 6 shows the next step of the filter element production;

FIG. 7 shows the finished filter element;

FIG. 8 shows schematically a detail of an air filter comprising a flat filter element and being arranged in a filter housing, in accordance with a second embodiment;

FIG. 9 shows schematically a third embodiment of a flat filter element whose filter element frame has a support frame; and

FIG. 10 shows schematically a detail of an air filter comprising a flat filter element in accordance with a fourth embodiment, wherein the filter element frame forms a part of the housing.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of apparatus components and method steps related to a method of producing a rectangular lat filter element. Accordingly, the apparatus components and/or method have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

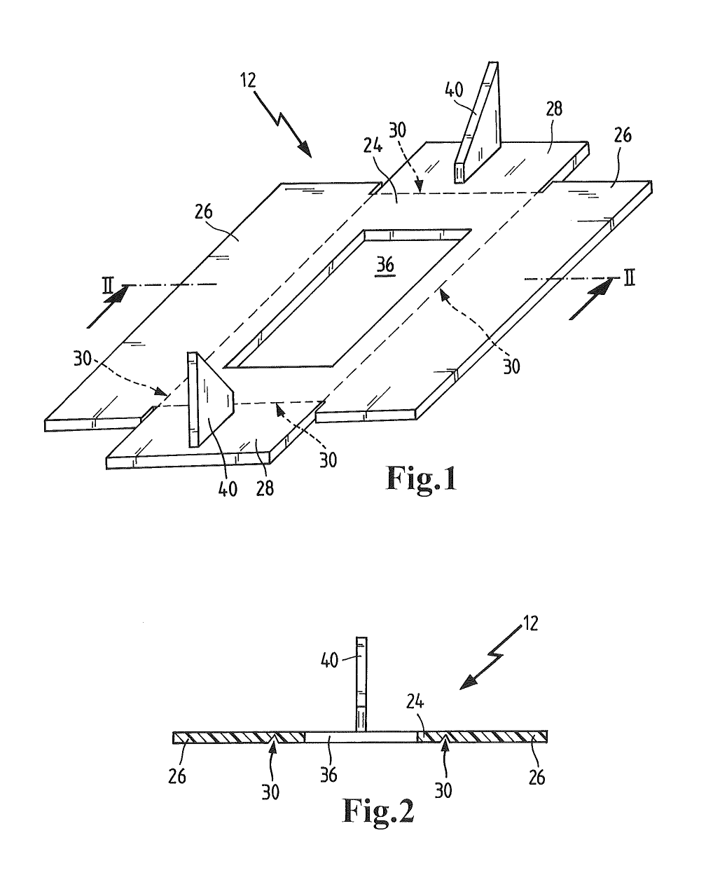

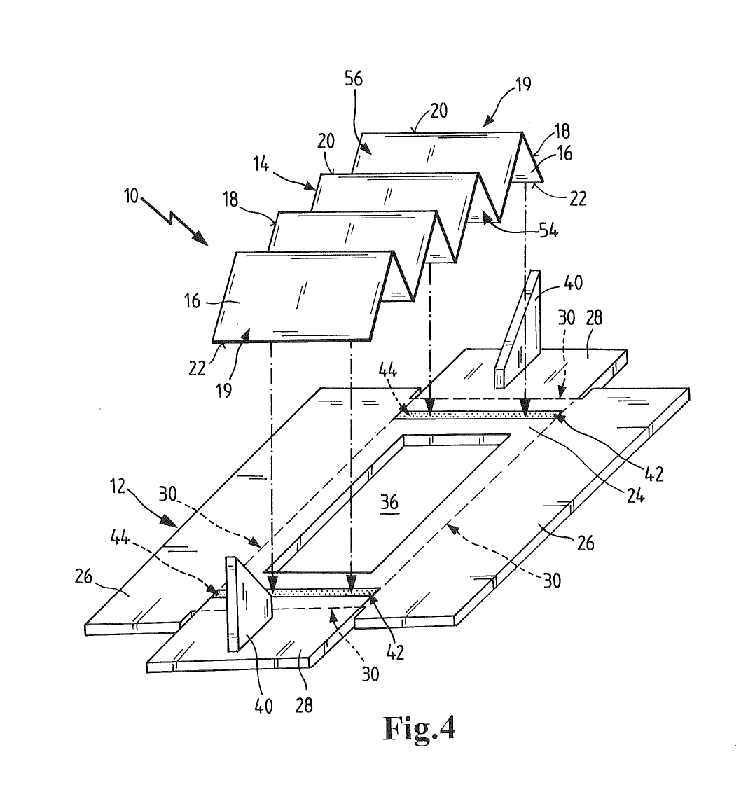

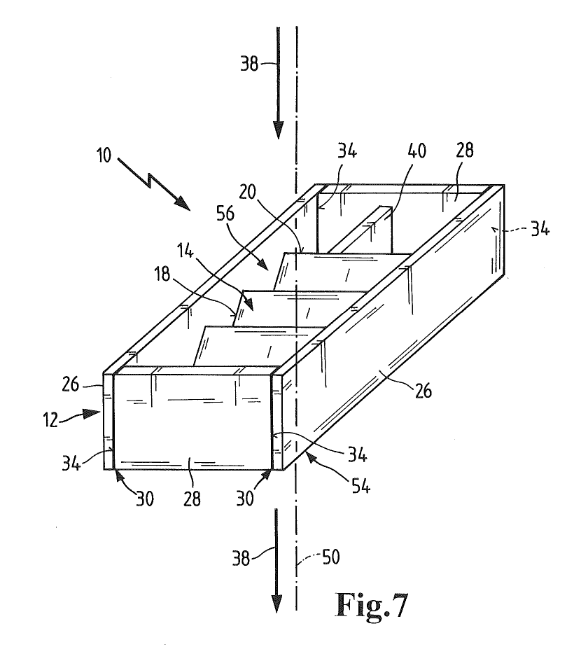

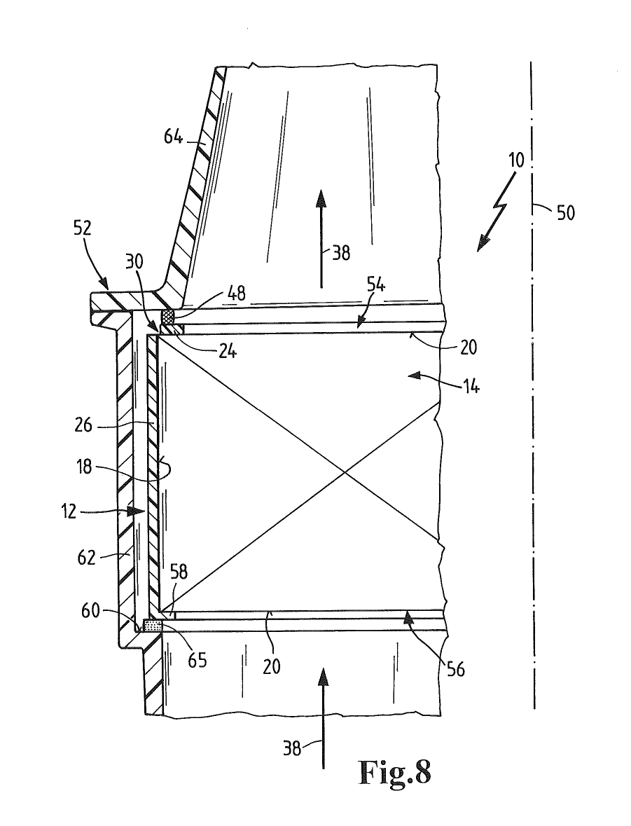

In FIGS. 1 to 7 a rectangular flat filter element is illustrated in different phases of its production. The flat filter element is identified in FIGS. 4 to 7 as a whole with reference character 10. FIG. 2 shows a section of the filter element frame 12 of the flat filter element 10 according to section line II-II of FIG. 1. The finish-mounted flat filter element 10 is illustrated in FIG. 7. The flat filter element 10 can be mounted in a filter housing of an air filter for filtering combustion air of an internal combustion engine. This is described in an exemplary fashion with the aid of the second embodiment disclosed farther below and illustrated in FIG. 8. The flat filter element 10 can be simply exchanged as needed, for example, when reaching a load limit.

The flat filter element 10 comprises a filter bellows 14 illustrated the FIGS. 4 to 7 comprised of zigzag-shaped folded filter medium. The imaginary envelope of the filter bellows 14 is of a parallelepipedal shape. The filter bellows 14 has a filtered air side 54, in FIGS. 4 to 7 at the bottom, an unfiltered air side 56, at the top, two end faces 19, shown in FIGS. 4 to 7 at the front and at the rear, and two lateral edges to the right and to the left. The filter bellows 14 is open at its end face folds 16 and its lateral edges 18, which means that neither the end face folds 16 nor the lateral edges 18 are connected to each other. The end face folds 16 are the outermost folds at the end faces 19 of the filter bellows 14. They extend parallel to the fold edges 20 where the filter medium is folded. The lateral edges 18 have the zigzag shape of the fold configuration.

Two end edges 22 of the end face folds 16 are positioned on the same filtered air side 54 of the filter bellows 14 that is facing the base frame part 24 of the filter element frame 12 in FIGS. 4 to 7.

The filter element frame 12 is made of plastic material and comprises the rectangular base frame part 24, two rectangular lateral frame parts 26, and two rectangular end face frame parts 28. The lateral frame parts 26 and the end face frame parts 28 are positioned at a right angle relative to each other and to the base frame part 24.

The lateral frame parts 26 are connected at opposite sides of the base frame part 24 by film hinges 30 monolithically and air-tightly to the base frame part 24. On the two other opposite sides of the base frame part 24, the end face frame parts 28 are also connected by means of film hinges 30 monolithically and air-tightly to the base frame part 24.

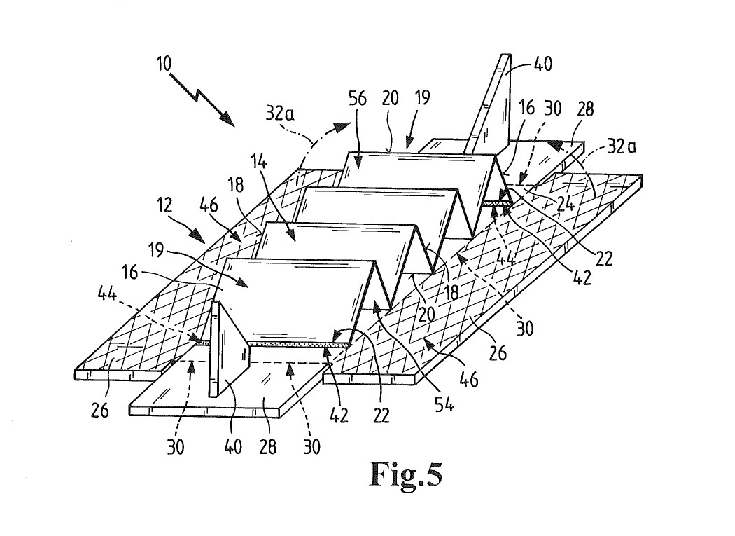

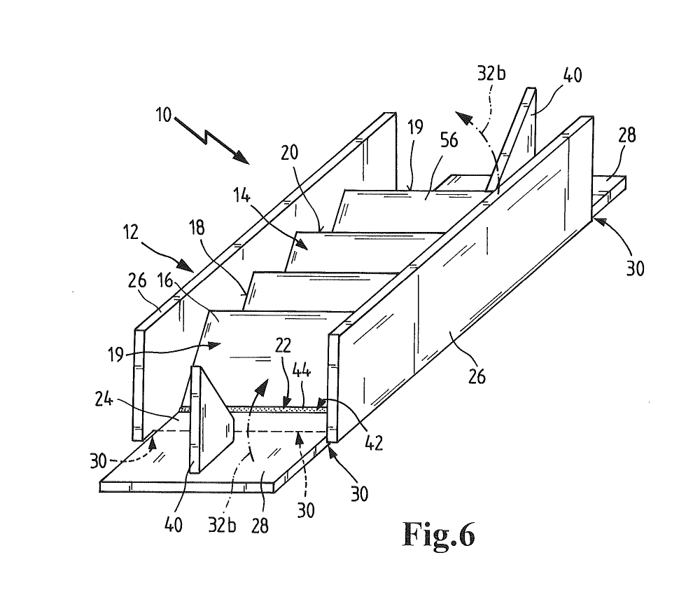

The film hinges 30 are realized in the form of straight notches on the side facing the filter bellows 14 of the initially flat filter element frame 12. The film hinges 30 of the lateral frame parts 26 are illustrated in section in FIG. 2. The notches define bending lines that are illustrated in dashed lines in FIGS. 1 and 3 to 6 where the lateral frame parts 26 or the end face frame parts 28 can be folded relative to the base frame part 24 toward the filter bellows 14. The respective folding directions are indicated in FIGS. 5 and 6 by arrows 32a and 32b.

The lateral frame parts 26 and the end face frame parts 28 are glued together at the edges 34 where they abut each other in an air-tight way (FIG. 7).

The base frame part 24 has a rectangular air passage opening 36 illustrated in FIG. 1 through 4. The air passage opening 36 in relation to the external dimensions of the base frame part 24 is of such a size that the base frame part 24 is basically forming a stable frame for the filter bellows 14. The unfiltered air can flow from the unfiltered air side 56 through the filter bellows 14 and thereby be filtered and purified. The filtered air can then flow at the filtered air side 54 through the air passage opening 36 out of the filter element 10. The main flow direction into the flat filter element 10 and out of it is indicated by arrows 38 in FIG. 7.

The end face frame parts 28 have each a guide wedge 40 extending in the finish-mounted flat filter element 10 (FIG. 7) to the respective end face fold 16 of the filter bellows 14; its slanted sides rest flat against the end face fold 16. Already during the folding action of the end face frame parts 28 into their end position, the end face folds 16 are pressed against the base frame part 24 by means of the guide wedges 40.

The filter bellows 14, as shown in FIGS. 5 and 6, is glued air-tightly with the end edges 22 into a groove 44 of the base frame part 24, respectively, by means of a melt adhesive 42. The two grooves 44 extend between the two lateral frame parts 26 parallel to the end face frame parts 28. The grooves 44 serve for receiving the melt adhesive 42 and define reproducibly the position for the end edges 22.

The lateral edges 18 of the filter bellows 14, as shown in FIGS. 6 and 7, are connected air-tightly by means of a highly viscous adhesive 46, indicated by cross-hatching in FIG. 5, with the respective lateral frame parts 26.

The filter bellows 14, as shown in FIG. 7, is thus secured as a whole in the filter element frame 12.

The manufacture of the flat filter element 10 is realized as described in the following.

The filter element frame 12 is first formed as a substantially flat component (FIG. 1) wherein the guide wedges 40 and the film hinges 30 are also introduced in the same process step.

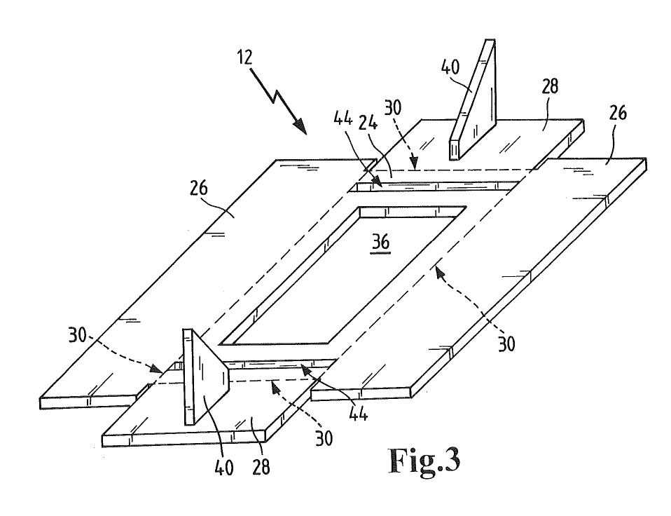

The grooves 44 are introduced into the base frame part 24 (FIG. 3). This can be done also in the same process step together with the application of the guide wedges 40 and the film hinges 30 or can be done prior to this.

The filter medium is folded in a zigzag shape to a filter bellows 14 such that the end edges 22 of the end face folds 16 are located on the same side of the filter bellows 14 (FIG. 4). The number of folds is predetermined.

The melt adhesive 42 is filled into the grooves 44.

The end edges 22 of the filter bellows 14 are inserted into the melt adhesive 42 so that they realize an airtight connection between the filter bellows 14 and the base frame part 24.

The thixotropic adhesive 46 is applied across the surface area of the lateral frame parts 26 (FIG. 5). The lateral frame parts 26 are folded in the folding direction 32a by 90 degrees at the film hinges 30 toward the lateral edges 18 of the filter bellows 14. The lateral edges 18 are pressed into the thixotropic adhesive 46, the latter expands and encloses air-tightly the lateral edges 18 in an area that, relative to the entire filter surface area, is very narrow. The folding action of the two lateral frame parts 26 can be done simultaneously or sequentially.

The two end face frame parts 28 are folded in the folding direction 32b by 90 degrees relative to the base frame part 24 (FIG. 6). When doing so, with the guide wedges 40 of the end face frame parts 28 the end face folds 16 are forced against the base frame part 24 and pressed into the melt adhesive 42. The folding action of the end face frame parts 28 can also be done prior to or simultaneous with folding of the lateral frame parts 26.

The sides of the lateral frame parts 26 and of the end face frame parts 28 that abut each other are glued together so as to be airtight. This can also be done in one process step together with folding of the end face frame parts 28 and the lateral frame parts 26.

The filter element frame 12 is swiveled or moved back and forth in different spatial directions until hardening of the melt adhesive 42 and of the thixotropic adhesive 46 has occurred. This is done in order to prevent that the adhesive 46 or the melt adhesive 42 will flow off the respective connecting locations while it is still soft. After hardening of the adhesive 46 and the melt adhesive 42, the filter bellows 14 is airtightly and stably connected to the filter element receptacle 12.

Finally, the seal 48 is attached to the filter element frame 12.\

A detail of a second embodiment of a flat filter element 10 that is installed in a filter housing 52 of a motor vehicle air filter is illustrated in section in FIG. 8. Those elements that are similar or identical to those of the first embodiment described in connection with FIGS. 1 to 7 are identified with the same reference characters so that reference is being had to the description of the first embodiment in connection with these similar or identical elements.

The second embodiment differs from the first in that the sides of the lateral frame parts 26 and of the end face frame parts 28 that are facing away from the base frame part 24 each have a collar or step 58 that extends radially toward the axis 50 of the flat filter element 10. The collar 58 surrounds in a stabilizing fashion the filter bellows 14 on the side opposite the base frame part 24. The seal 48 is attached to the base frame part 24 and is positioned against the housing cover 64 so that the filtered air side 54 is separated from the unfiltered air side 56. At the unfiltered air side the filter element 10 has preferably flexible spacers 65 that facilitate the clamping action and enable tolerance compensation.

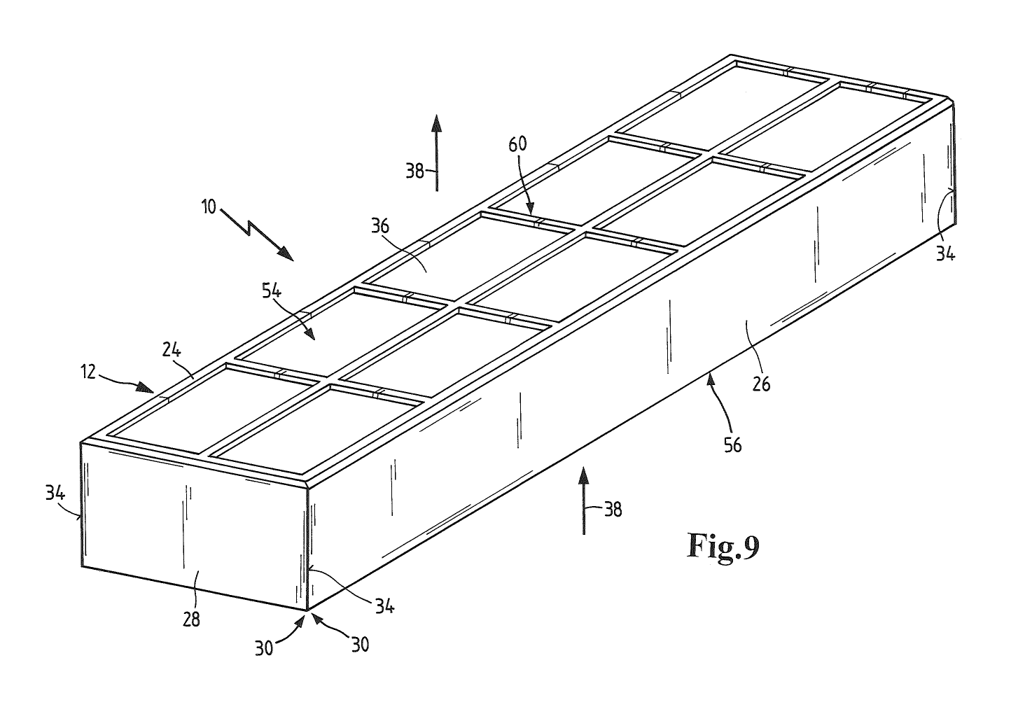

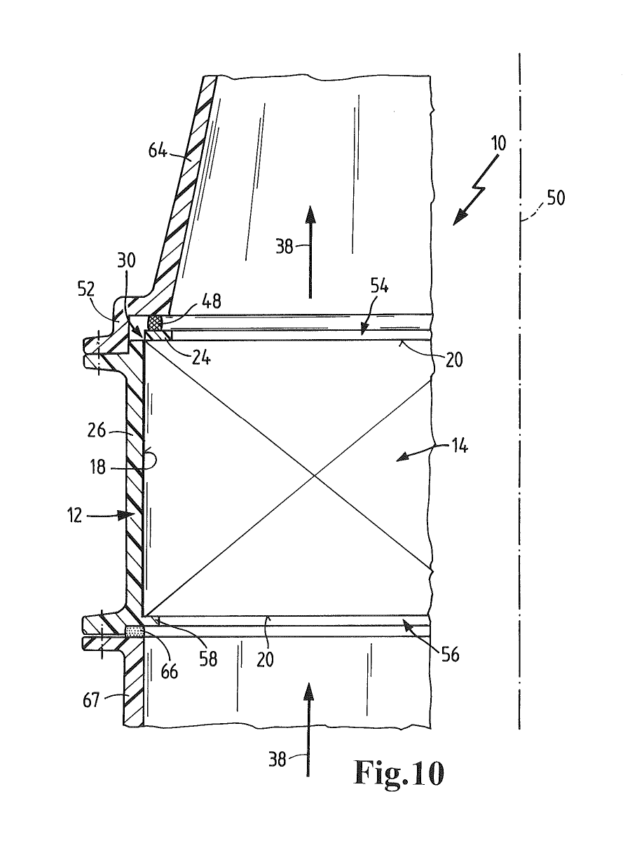

In FIG. 9 a third embodiment of a flat filter element 10 is illustrated in a viewing direction onto the base frame part 24. Those elements that are similar or identical to those of the embodiment illustrated in FIGS. 1 to 7 are identified with the same reference characters so that reference is being had to the description of the first embodiment in respect to these similar or identical elements.

In contrast to the first embodiment, in the air passage opening 36 a support frame 60 is provided that is formed monolithically with the base frame part 24.

In FIG. 10, a further embodiment of a flat filter element 10 in a filter housing 52 is shown. The lateral frame parts/end face frame parts 26, 28 simultaneously form a part of the filter housing 52. The filter element 10 is fastened by fasting means (for example, screws or snap connectors, not illustrated) between housing cover 64 and housing bottom part 67. The seal between the unfiltered air side 56 and the filtered air side 54 is realized by means of seal 48 that is attached to the base frame part 24 or to the housing cover 64. At the unfiltered air side, the flat filter element 10 has a further seal or a flexible element 66 for tolerance compensation.

In all of the above described embodiments of a flat filter element 10 and a method for producing the same, the following modifications are possible inter alia.

The invention is not limited to rectangular flat filter elements 10 for filtering combustion air. Instead, it can be used also for types of flat filter elements for filtering other liquid or gaseous fluids, for example, oil, water or fuel, and can also be used in applications outside of internal combustion engines, in particular for motor vehicles.

The main flow direction 38 can also be reversed through the flat filter element 10 so that the unfiltered air enters the flat filter element 10 by passing through the air passage opening 36.

The flat filter element 10, instead of being rectangular, can also be shaped differently, for example, can be curved or arcuate.

The filter medium, instead of being folded in zigzag shape, can also be folded differently, for example, in a corrugated or wavy shape.

Instead of being connected with its end edges 22, the filter bellows 14 can also be connected with other areas of its end face folds 16, for example, the fold edge 20, with the filter element frame 12.

The end edges 22 of the end face folds 16, instead of being on the same side, i.e., the unfiltered air side 56 or the filtered air side 54 of the filter bellows 14, can also be arranged on opposite sides. In this case, the filter bellows 14 can be connected to the filter element frame 12 with the end edge 22 at the first end face 19 and with the fold edge 20 at the second end face 19.

Instead of being connected with the base frame part 24, the folded filter medium can be connected in the area of its end face folds 16 also with the end face frame parts 28 of the filter element frame 12.

In place of the film hinges 30, it is also possible to use other types of bending connections that provide a fluid-tight flexible connection of the corresponding lateral frame parts 26 and 28 with the base frame part 24.

Instead of being folded from a single piece, the filter element frame 12 can also be combined in a fluid-tight way of separate lateral frame parts 26, a separate base frame part 24 and separate end face frame parts 28.

In place of the guide wedges 40, different kinds of guide members can be provided, preferably at the end face frame parts 28. Also, several guide wedges 40 can be arranged on each end face frame part 28.

One or both end face frame parts 28 may be omitted. The base frame part 24 and the lateral frame parts 26 can be stabilized in other ways and can be sealed relative to the filter housing 52 in order to separate air-tightly the unfiltered air side 56 from the filtered air side 54.

The lateral edges 18 of the filter bellows 14, instead of being connected by means of a viscous adhesive 46, can also be fluid-tightly connected in other ways with the lateral frame parts 26. For example, the lateral edges 18 can also be connected by means of plate welding/fusing or by IR welding/fusing in a fluid-tight way with the lateral frame parts 26. It is also possible to prepare a special adhesive film on the lateral frame parts 26; this adhesive film has the property that upon pressing in the lateral edges 18 or by heating, for example, by means of IR radiation, it is activated, expands, and encloses the lateral edges 18 in a defined way within a narrow area. The end edges 22 can be connected in a similar manner with the base frame part 24 instead of using here the melt adhesive 42.

The lateral frame parts 26 can have additionally depressions or grooves for receiving an adhesive 46. They can be designed such that they correspond to the zigzag course of the lateral edges 18 so that the filter bellows 14 is additionally stabilized and its shape is predetermined in a defined and reproducible way.

The grooves 44 in the base frame part 24 may be omitted. The end edges 22 can be connected without use of grooves 44, for example, by means of plate welding/fusing in a fluid-tight way with the base frame part 24 wherein the position of the end edges 22 can be predetermined by precise partial softening of the base frame part 24.

Instead of being glued, the lateral frame parts 26 and the end face frame parts 28 can also be connected in other ways at the abutting sides, for example, by means of welding/fusing or the above described special adhesive film, in a fluid-tight way.

Instead of being arranged on the flat filter element 10, the sealing device can be arranged also on the filter housing 52 that is a permanent component.

In the production process, instead of first connecting the end edges 22 of the filter bellows 14 with the base frame part 24, it is possible to first connected one of the lateral edges 18 with the corresponding lateral frame part 26. This lateral frame parts 26 can subsequently be folded relative to the base frame part 24. The end edges 22 of the filter bellows 14 can then be connected with the base frame part 24. Subsequently, the second lateral frame part 26 can be folded relative to the base frame part 24 and connected with the second lateral edge 18 of the filter bellows 14.

When using separate lateral frame parts 26, first in a single process step the two lateral frame parts 26 can be connected to the filter bellows 14. Subsequently, the base frame part 24 can be connected to the filter bellows 14 and the lateral frame parts 26.

While specific embodiments of the invention have been shown and described in detail to illustrate the inventive principles, it will be understood that the invention may be embodied otherwise without departing from such principles.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for producing a flat filter element for fluids, the method comprising:
folding a filter medium to a filter bellows having end face folds and lateral edges;
providing a solid filter element frame; and
connecting fluid-tightly the filter bellows in an area of the end face folds to the solid filter element frame and connecting fluid-tightly the lateral edges of the filter bellows to the solid filter element frame so that the filter bellows is secured in the filter element frame.

2. The method according to claim 1, wherein
in the step of folding, the filter medium is folded in a zigzag shape.

3. The method according to claim 1, wherein
in the step of folding, the filter medium is folded such that end edges of the end face folds are located on the same side of the filter bellows.

4. The method according to claim 1, wherein the method further comprises:
providing each one of the end face folds with an end edge and a fold edge; and
fluid-tightly connecting at least one of the end edge and the fold edge to the filter element frame.

5. The method according to claim 1, wherein the method further comprises:
providing the filter element frame with a base frame part and lateral frame parts;
fluid-tightly connecting the filter bellows in the areas of the end face folds with the base frame part and the lateral edges with the lateral frame parts.

6. The method according to claim 5, wherein the method further comprises:
connecting the lateral frame parts and the base frame part fluid-tightly to each other.

7. The method according to claim 5, wherein the method further comprises:
providing the filter element frame with end face frame parts extending between the lateral frame parts, respectively; and
fluid-tightly connecting the end face frame parts to the base frame part and the lateral frame parts.

8. The method according to claim 7, wherein the method further comprises:
connecting the lateral frame parts and the end face frame parts fluid-tightly to each other by an adhesive or by welding or fusing.

9. The method according to claim 7, wherein the method further comprises:
providing the end face frame parts with guide members; and
pressing the end face folds with the guide members against the base frame part.

10. The method according to claim 5, wherein the method further comprises:
providing the lateral frame parts, the base frame part, and optionally the end face frame parts as separate frame parts; and
forming the filter element frame by fluid-tightly connecting the lateral frame parts, the base frame part, and optionally the end face frame parts.

11. The method according to claim 5, wherein the method further comprises:
providing the lateral frame parts, the base frame part and optionally the end face frame parts as a monolithic component connected by bending connections; and
folding the lateral frame parts, the base frame part and optionally the end face frame parts to shape the filter element frame.

12. The method according to claim 1, wherein
in the connecting step, the filter bellows is connected to the filter element frame by an adhesive or by fusing or welding.

13. The method according to claim 11, wherein the method further comprises
providing the filter element frame with receptacles, introducing an adhesive into the receptacles; and
pressing the areas of the end face folds to be connected to the filter element frame and/or the lateral edges to be connected to the filter element frame into the adhesive in the receptacles.

14. The method according to claim 1, wherein the method further comprises:
employing a highly viscous adhesive in the step of connecting fluid-tightly the filter bellows; and
swiveling back and forth in various spatial directions the filter element frame until the adhesive is hardened.

15. A flat filter element for fluids, the flat filter element comprising:
a filter bellows comprised of a folded filter medium, said filter bellows having end face folds and lateral edges; and
a solid filter frame, wherein said filter bellows is fluid-tightly connected with said lateral edges to said filter element frame and fluid-tightly connected in an area of said end face folds to said filter element frame such that said filter bellows is secured in said filter element frame.

16. The flat filter element according to claim 15, wherein
said filter medium is folded in a zigzag shape.

17. The flat filter element according to claim 15, wherein
said end face folds each have an end edge and said end edges are located on a same side of said filter bellows.

18. The flat filter element according to claim 17, wherein
said end face folds have a fold edge opposite said end edge, and
wherein at least one of said end edge and said fold edge of at least one of said end face folds is fluid-tightly connected with said filter element frame.

19. The flat filter element according to claim 15, wherein
said filter element frame comprises
a base frame part; and
lateral frame parts connected to opposite sides of said base frame part;
wherein said filter bellows, in areas of said end face folds, is fluid-tightly connected to said base frame part and said lateral edges of said filter bellows are connected fluid-tightly to one of said lateral frame parts, respectively.

20. The flat filter element according to claim 19, wherein
said filter element frame comprises at least one end face frame part having a guide member;
wherein said end face folds are pressed against said base frame part by said guide member.

21. The flat filter element according to claim 20, wherein
said lateral frame parts, said base frame part and optionally said end face frame parts are connected by bending connections to a monolithic component.

22. The flat filter element according to claim 15, comprising:
a sealing device that is adapted to fluid-tightly separate a filtered fluid side of the flat filter element from an unfiltered fluid side of the flat filter element when the flat filter element is arranged in a filter housing.

23. A filter device for fluids, the filter device comprising
a filter housing; and
a flat filter element according to claim 15, disposed in said housing.
